(19) United States
(12) Patent Application Publication
(10) Pub. No.: US 2015/0083819 A1
(43) Pub. Date: Mar. 26, 2015

(54) ACRYLIC WATER FEATURES

(71) Applicant: Anthony Andrew Cibulski, Birmingham, AL (US)

(72) Inventor: Anthony Andrew Cibulski, Birmingham, AL (US)

(21) Appl. No.: 14/033,222

(22) Filed: Sep. 20, 2013

(51) Int. Cl. B05B 17/08

(52) U.S. Cl. CPC B05B 17/08
USPC 239/17

(57) ABSTRACT

A illuminated table or desk top water display ornament can be used for everyday enjoyment and appropriate for every season and occasion. The water display ornaments embody a multiplicity of water displays, such as waterfalls, springs, waves, tides, cavitating bubbles, and the like, all combined and cycled in one system. The water display ornaments are simple in construction and maintain an aesthetically pleasing presentation to the viewer. Many options are available as a plug-in or slide-in module. This allows the viewer to change modules if desired to obtain different patterns, flows and sounds as desired. The water display ornaments can be efficacious modalities for attenuating an individual's adverse response to daily, weekly, annual or seasonal circadian cycles, such as seasonal affective disorder. Moreover, the water display ornaments offer life prolonging benefits similar to that attributed, by anecdotal evidence, to the ownership of a pet.

### BACKGROUND OF THE INVENTION

The present invention relates to acrylic water features and, more particularly, to an illuminated waterfall ornament having various modules for creating various water effects.

In an era of extreme stress and insane chaos, the demand for anxiolytics, anti-depressants and insomniolytics has increased at an alarming rate. Therefore, there have been efforts made in the development of non-pharmaceutical strife liberating approaches to conquer these personal burdens. Water displays have been developed for providing a serene and relaxing visual and audial effect for the user.

Conventional water displays, such as those designed for a desk or table top, are non-dynamic and unchanging, resulting in eventual apathy and disinterest.

These conventional water displays often lack illumination and are devoid of any changing water patterns and, therefore, produce the same auditory frequencies.

Moreover, with conventional water displays, the user typically cannot control the device's operation beyond turning the water pump on or off. There are typically no options for changing the display or providing different effects simply and conveniently.

As can be seen, there is a need for an improved table or desk top water display ornament that has the ability to provide multiple visual and audial effects for the user.

### SUMMARY OF THE INVENTION

In one aspect of the present invention, a water display ornament comprises a transparent reservoir for containing water; a plurality of lights disposed below a bottom portion of the reservoir; a pump disposed inside the reservoir; a pressure chamber fed by the pump via a pump to pressure chamber tube; and at least one module operable to receive water flow from the pressure chamber, wherein the at least one module includes at least one of a slide-in waterfall module, a fountain and tides display module; a sphere module, and an aqua burst module.

These and other features, aspects and advantages of the present invention will become better understood with reference to the following drawings, description and claims.

### BRIEF DESCRIPTION OF THE DRAWINGS

FIG. 1 is a perspective view of an illuminated waterfall ornament according to an exemplary embodiment of the present invention;

FIG. 2 is a cross-sectional view taken along line 2-2 of FIG. 1;

FIG. 3 is a cross-sectional view of the pressure chamber of the illuminated waterfall ornament of FIG. 1;

FIG. 4 is a perspective view of a slide-in module for the illuminated water ornament of FIG. 1;

FIG. 5 is a schematic front view illustrating water oscillation in the slide-in module chamber;

FIG. 6 is a top view of a double slide-in module chamber for the illuminated water ornament of FIG. 1;

FIG. 7 is a schematic front view illustrating water oscillation in the double slide-in module chamber of FIG. 6;

FIG. 8 is a front view of a central reservoir fountain display of an illuminated water ornament according to an exemplary embodiment of the present invention;

FIG. 9 is a front view of a spherical fountain with a high velocity, low volumetric inflow and low grade obstruction to outflow, usable with the central reservoir fountain display of FIG. 8;

FIG. 10 is a front view of a spherical fountain with reduced velocity, higher volumetric inflow and a slightly restricted outflow, usable with the central reservoir fountain display of FIG. 8;

FIG. 11 is a front view of a spherical fountain with a large inflow nozzle producing a low velocity, high volumetric flow and a restricted outflow, usable with the central reservoir fountain display of FIG. 8;

FIG. 12 is a front view of a spherical fountain multiple micro pores producing glittering dynamic micro geysers along the surface of the spherical fountain, while an occluded orifice is provided at the inflow site;

FIG. 13 is a side view of the central reservoir fountain display of FIG. 8;

FIG. 14 is a front view of a fountain and tides display module, illustrating a high tide phase;

FIG. 15 is a front view of the fountain and tides display module of FIG. 14, illustrating a low tide phase;

FIG. 16 is a side view of an aqua burst display module;

FIG. 17 is a front view of the aqua burst display module of FIG. 16;

FIG. 18 is a front view of an aqua burst display module; and

FIG. 19 is a front view of the aqua burst display module.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an illuminated table or desk top water display ornament for everyday enjoyment and appropriate for every season and occasion. The water display ornaments embody a multiplicity of water displays, such as waterfalls, springs, waves, tides, cavitating bubbles, and the like, all combined and cycled in one system. This can be accomplished without the use of failure prone electrical and mechanical modules. The water display ornaments are simple in construction and maintain an aesthetically pleasing presentation to the viewer. Many options are available as a plug-in or slide-in module. This allows the viewer to change modules if desired to obtain different patterns, flows and sounds as desired. The water display ornaments can be efficacious modalities for attenuating an individual's adverse response to daily, weekly, annual or seasonal circadian cycles, such as seasonal affective disorder. Moreover, the water display ornaments offer life prolonging benefits similar to that attributed, by anecdotal evidence, to the ownership of a pet.

The water display ornaments, as herein described, can be made from various materials, such as an acrylic frame adorned with an artfully designed arrangement of stained mosaic glass, decorative accent marbles, 6/0 glass beads, grafting bead jewelry, decorative accent marbles, mosaic acrylic gems, and the like. The decorative glass can be bonded to the acrylic frame with castolite, for example, while the decorative acrylic marbles and gems can be bonded with acrylic glue.

The structures described herein, as discussed below, can be illuminated with a grid of lights, such as light emitting diodes (LEDs) using white mono-colored, multi-colored, or programmable-colored lights. LEDs serve as a long lasting, low heat source of illumination and provides a fabulous decorative contribution to the water display ornament.

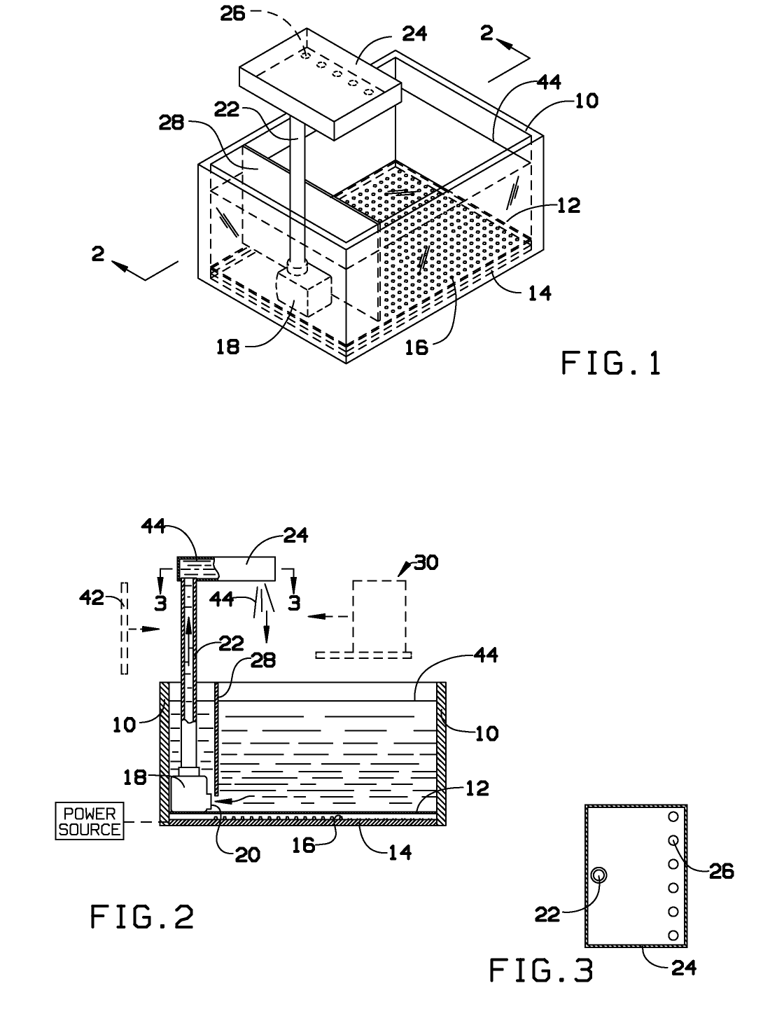

Referring now to FIGS. 1 through 4, a water display ornament can include a reservoir formed from reservoir side walls 10 and a reservoir bottom 12. A light plate, such as an LED plate 14, containing a plurality of LEDs 16 can be disposed below the reservoir bottom 12 to provide illumination through the reservoir bottom 12 and into water 44 disposed in the reservoir.

A pump 18 can be disposed at one side of the reservoir. The pump 18 can include a pump intake 20 for feeding water 44 thereinto.

A tube 22 can extend from the pump 18 to carry pump outflow water into a pressure chamber 24 disposed at the end of the tube 22. A plurality of pressure chamber outflow holes 26 are disposed in the pressure chamber 24 to allow water 44 pumped by the pump 22 to flow out therefrom. A mirror 28 can be disposed in the reservoir to at least partially conceal the pump 18 and tube 22.

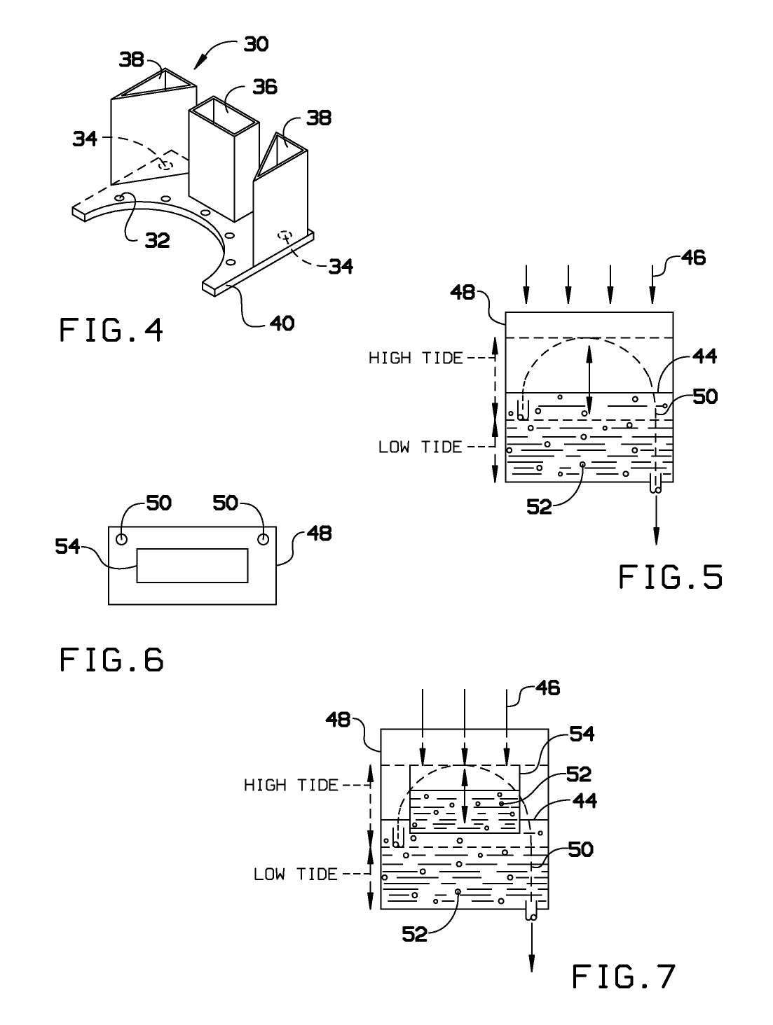

A module, such as a slide-in waterfall module 30 can be placed under the holes 26 to receive water therein. The slide-in waterfall module 30 can take various designs and can be changed, as desired, by the user. One embodiment of such a slide-in waterfall module 30 is shown in FIG. 4, where the module includes side chambers 38 and a center chamber 36. Chamber holes 34 can be used for water outflow, or may be interconnected with a pressure chamber (as described below) to provide a water source. Fountain holes 32 can be provided in the slide-in waterfall module 30 to allow water to exit therefrom.

In some embodiments, as shown in FIG. 5, one or more of the chambers 36, 38, typically central chamber 36, can be designed to vary its water height. A siphon tube 50 can be disposed within the variable chamber 48 to allow water to drain to a predetermined level once water reaches a maximum level. This can provide the appearance of a changing water level, or tides. As can be seen in the Figure, the waterfall 46 from the pressure chamber 24 causes cavitation bubbles 52 in the water 44, further enhancing the visual display.

In some embodiments, as shown in FIGS. 6 and 7, the chamber 36 can be modified to include an inner reservoir 54 within the variable chamber 48. This embodiment may allow the inner reservoir 54 to fill, before allowing water to flow into the variable chamber 48, thus providing even greater dynamics for the viewer to see variable water levels in the water display ornament.

A light plate, such as a side LED plate 42 can be disposed behind the slide-in waterfall module 30 to provide an additional illuminated display.

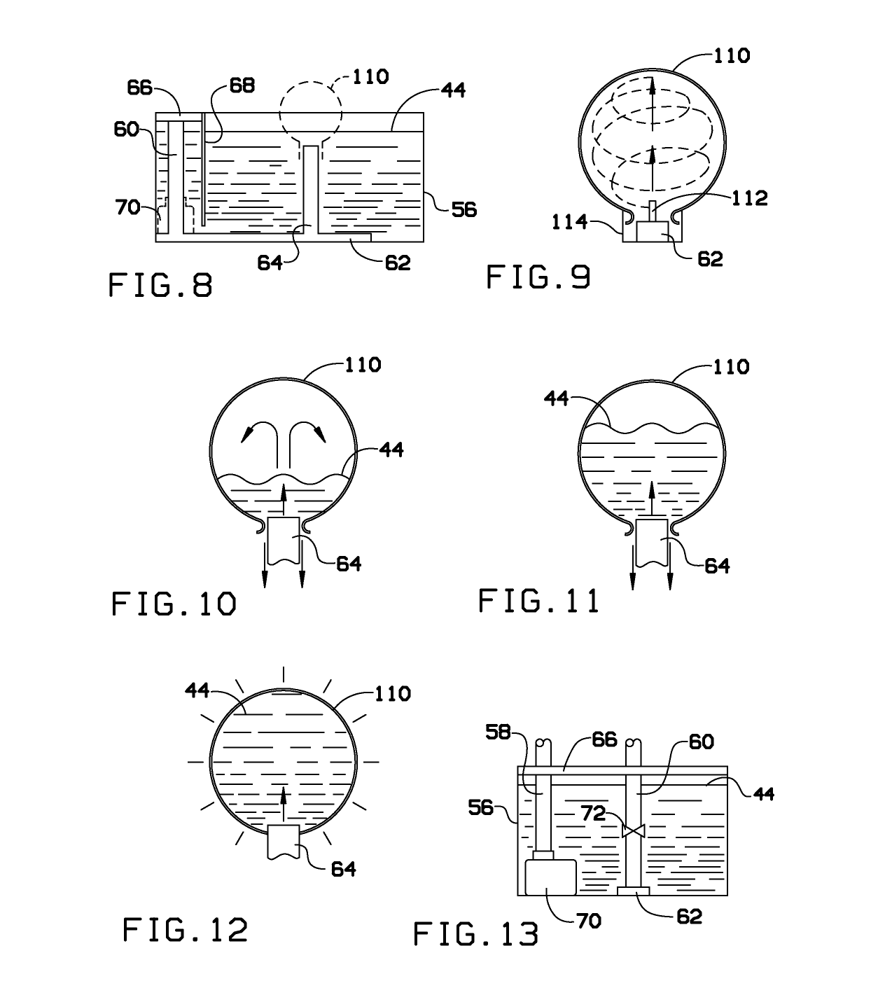

Referring now to FIGS. 8 through 13, a water display ornament can include a central reservoir 56 having a pump 70 disposed therein. A pump to pressure chamber tube 58 can extend to a pressure chamber 66 disposed at an upper surface of the reservoir 56 from the pump 70. A pressure chamber to channel tube 60 can extend from the pressure chamber to a channel 62, as described below. FIG. 13 illustrates a side view of the water display ornament, showing a flow control valve 72 on the tube 60 to control flow between the pressure chamber 66 and the channel 62.

The channel 62 can extend along a bottom portion of the reservoir 56 from the pump 70 to deliver water flow to a central reservoir fountain tube 64 extending from the channel 62 at the bottom of the reservoir 56 toward a surface of the water 44 therein. A sphere 110 can be disposed on the end of the tube 64.

Similar to the embodiment described above, a mirror 68 can be used to at least partially hide the tube 60 and the pump 70.

The sphere 110 can be designed to provide various effects. The sphere 110 can be easily changed, for achieving these various effects, by simply removing the sphere 110 from the tube 64 via a sphere mount 114. In one embodiment (FIG. 9), the sphere can have a high velocity, low volumetric inflow and a low grade obstruction to outflow. In this design, the higher velocity nozzle 112 causes water to strike the vertex of the sphere and spiral downward along the inner surface of the sphere to the exit. At first glance, it appears as though the sphere is spinning until the observer appreciates the swirling action of the water. In another embodiment (FIG. 10), a slightly larger nozzle produces a lower velocity jet, a higher volumetric flow, and a more restrictive aperture for outflow. In this system design, the resulting geyser approaches the sphere's vertex and falls back to the body of undulating water that accumulates to a height to equilibrate the inflow and outflow. In a further embodiment (FIG. 11), a large inflow nozzle produces a low velocity, high volumetric flow and a greater restriction to sphere outflow. The inflow jet is invisibly embedded in the sphere's body of undulating water that accumulates in height to balance the inflow and outflow. In this display, the body of water within the sphere with dynamic waves appears to have no visible means of propulsion to explain its existence. In another embodiment (FIG. 12), the sphere can be fenestrated with numerous micro pores and an occluded orifice at the inflow site. Thus, numerous glittering dynamic micro geysers are produced along the surface of the sphere. To account for hydrostatic pressure differences within the sphere, the caliber of the micro pores decrease from vertex to lower levels (for example, from about 1/16 inch to about 1/24 inch).

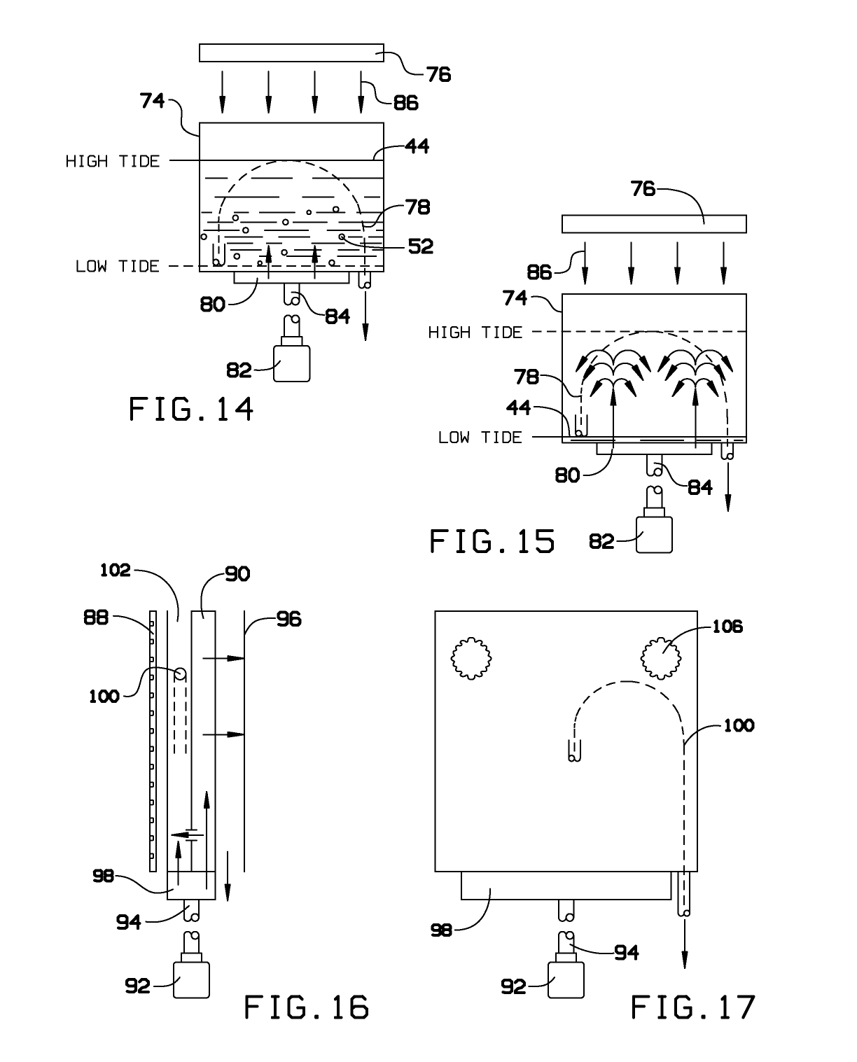

The water display ornament of the present invention can include a fountain and tide display, as shown in FIGS. 14 and 15. With this display, a reservoir 74 can be disposed below a low pressure chamber 76 to receive water therefrom. Water can also be supplied via a fountain pump 82 and pump tube 84 to a pressure chamber 80. Water can enter the reservoir 74 from the pressure chamber 80, as shown in FIG. 15, to form a fountain within the reservoir 74. As the water level increases to a high tide level, a siphon tube 78 can cause the water to be expelled from the reservoir 74 to a low tide level.

Referring now to FIGS. 16 through 19, an aqua burst display module can be used with the water display ornament of the present invention. In this module, water can be pumped via a pump 92, through a tube 94, to a pressure chamber 98. Water from the pressure chamber can enter an aqua jet chamber 90 to begin filling this chamber 90. Water can also pass through to a hydrostatic pressure chamber 102, especially as the volume of water increases in the aqua jet chamber 90. Once the water in the hydrostatic pressure chamber 102 reaches a predefined height, a siphon tube 100 can drain water from the aqua burst display to begin the cycle again.

The aqua jet chamber 90 can include a plurality of aqua jets 104, allowing water to jet therefrom and strike an acrylic plate 96. During the drainage phase of the hydrostatic pressure chamber 102, the hydrostatic pressure therein decreases, and flow into the chamber 102 increases from chamber 90, which decreases the pressure in the aqua jet chamber 90 and decreases the diameter of aqua bursts 106. During the filing phase of the chamber 102, the reveres of the hydrodynamic changes described above occurs. Thus, the aqua burst undergoes dynamic expansions and contractions for the added pleasure of the viewer. An additional aesthetical feature of entertainment in the display is the multicolored sparkles the emanate from the siphon 100 to be cavitating bubbles illuminated by an LED plate 88 during the transition from the drainage to the filling phase of the chamber 102. In addition, as the aqua bursts 106 disperse, a number of aqua satellites 108 are provided along the plate 96.

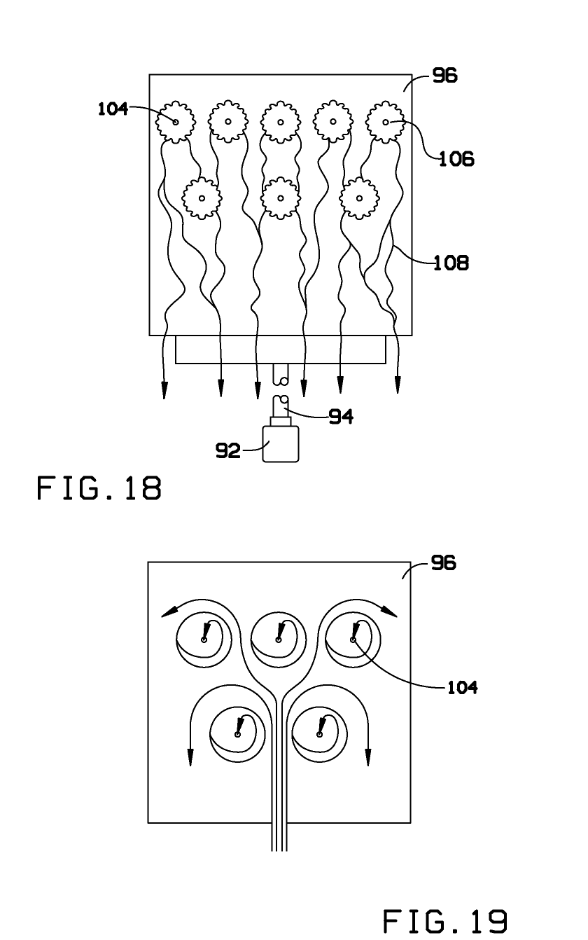

The vortices in FIG. 19 are generated in the pressure chamber 90 (see FIG. 16) with the introduction of bubbles in the pump. The bubbles can be formed, for example, with either bubble bath or an air pump.

It should be understood, of course, that the foregoing relates to exemplary embodiments of the invention and that modifications may be made without departing from the spirit and scope of the invention as set forth in the following claims.

What is claimed is:

1. A water display ornament comprising:
a transparent reservoir for containing water;
a plurality of lights disposed below a bottom portion of the reservoir;
a pump disposed inside the reservoir;
a pressure chamber fed by the pump via a pump to pressure chamber tube;
at least one module operable to receive water flow from the pressure chamber, wherein the at least one module includes at least one of a slide-in waterfall module, a fountain and tides display module; a sphere module, and an aqua burst module.

2. The water display ornament of claim 1, wherein the plurality of lights are LED lights.

3. The water display ornament of claim 1, further comprising a mirror disposed in the reservoir to at least partially block a view of the pump and the pump to pressure chamber tube.

4. The water display ornament of claim 1, wherein the at least one module is a slide-in waterfall module.

5. The water display ornament of claim 4, wherein the slide-in waterfall module includes a plurality of chambers receiving water from holes formed in the pressure chamber, wherein at least one of the plurality of chambers drains via a siphon tube when a predetermined fluid level is reached.

6. The water display ornament of claim 4, further comprising at least one fountain hole formed in the slide-in waterfall module to allow water to flow out therefrom.

7. The water display ornament of claim 5, wherein the at least one of the plurality of chambers that drains includes an inner chamber and an outer chamber.

8. The water display ornament of claim 1, further comprising a fluid passage extending from the pressure chamber to a central reservoir fountain tube extending upward from the bottom of the reservoir in a central region thereof.

9. The water display ornament of claim 8, further comprising a sphere disposed on top of the central reservoir fountain tube.

10. The water display ornament of claim 9, wherein the sphere has nozzle and a water outflow.

11. The water display ornament of claim 1, wherein the aqua burst module includes a hydrostatic pressure chamber that drains when a certain water level is reached, an aqua jet pressure chamber having a plurality of aqua jets disposed therein to permit water to jet outward therefrom, and a plate configured to receive water jetting outward from the aqua jet pressure chamber.

12. The water display ornament of claim 11, further comprising an LED light plate disposed adjacent to the aqua burst module.
